(19) United States
(12) Patent Application Publication
(10) Pub. No.: US 2003/0038977 A1
(43) Pub. Date: Feb. 27, 2003

(54) Browser-controlled faxing system and method

(76) Inventor: Brett Green, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/939,440

(22) Filed: Aug. 24, 2001

(51) Int. Cl. H04N 1/00

(52) U.S. Cl. 358/402

(57) ABSTRACT

The present disclosure relates to a browser-controlled faxing system and method. In one arrangement, the system and method involve receiving a fax request from a user browser, uploading content to the user browser, receiving a fax job from the user browser, and transmitting a facsimile to a recipient device. In one arrangement, the system and method can be implemented with a faxing device that comprises a processing device, faxing hardware, a networking device, and memory comprising a fax control module and an embedded server, the fax control module including logic for generating at least one control screen that can be uploaded to a user browser and at least one application that can also be uploaded to the user browser, the at least one application further being configured to perform a designated task on a computing device on which the user browser runs.

### FIELD OF THE INVENTION

The present disclosure relates to a browser-controlled faxing system and method. More particularly, the disclosure relates to a system and method in which the operation of a faxing device is controlled with a browser.

### BACKGROUND OF THE INVENTION

Peripheral devices are adapted to be accessed and used by computing devices such as a personal computer (PC). Traditionally, printers were accessible in this manner while other “office” devices were only configured for “walk-up” use. With the recent focus on networking technology, however, many other devices can be accessed and used with a host computing device. For example, photocopiers, facsimile machines, scanners, multifunction peripherals (MFPs) capable of several different functionalities traditionally conducted by separate devices, network appliances, etc. are currently available that are configured for this type of use.

This manner of use provides advantages that were previously unavailable to the user. For instance, if the user wishes to fax a word processing document to a recipient, the user has the option to transmit the document in electronic form from his or her computing device to a connected faxing device (e.g., facsimile machine or MFP) for faxing. In such a scenario, the user can save time and resources in not having to first print a hardcopy of the document and scan it into the faxing device. In addition, in that scanning is not necessary, less resolution loss (and therefore document degradation) occurs.

To enable such access and control, one or more software applications normally must be stored on the user's computing device. Such applications typically comprise a user interface and one or more device drivers. The user interface is provided as a means for receiving user commands and selections regarding the tasks the user wishes to be completed by the end device and the device drivers are configured to send jobs from the computing device to the end device to fulfill the requested tasks.

Typically, each end device to be accessed by the computing device has its own separate software application. Moreover, separate software applications are typically needed for each different functionality the end device performs where it performs more than one functionality (e.g., scanning, faxing, copying, and printing). Normally, these software applications are not standardized. Therefore, the layout of the user interface and the manner in which the end device is controlled may be different for each application, even for different devices made by the same manufacturer and for single devices that provide multiple functionalities.

The arrangement described above presents several disadvantages to the user as well as the device manufacturer. With regard to the user, the user must install separate software for each different device and/or functionality the user plans to use. In addition, the user may need to update this software when new software becomes available from the device manufacturer (e.g., updated driver software). This is very time-consuming for the user and places a burden upon the user to keep apprised of any software improvements that have been made by the device manufacturer. Once the software has been installed by the user, the user must become familiar with each different software application, both in terms of the user interface and the manner in which the software is used to control the device and/or functionality. This can be frustrating for the user, particularly where the user must access many different devices and/or functionalities.

In terms of the device manufacturer, disadvantages include having to reconfigure the software as the underlying operating environment (e.g., Windows™, Unix™) is changed by third parties as well as having to provide new software (for any purpose) to the various purchasers of a given device as the new software is developed. Furthermore, device manufacturers normally must provide customer support for all versions of software that have been produced in that some users may still have old versions of the software. In some situations, valuable time may be lost in just determining what software the user possesses.

From the foregoing, it can be appreciated that it would be desirable to have a system and method for accessing and using a device that avoids one or more of the difficulties identified above.

### SUMMARY OF THE INVENTION

The present disclosure relates to a browser-controlled faxing system and method. In one arrangement, the method comprises the steps of receiving a fax request from a user browser, uploading content to the user browser, receiving a fax job from the user browser, and transmitting a facsimile to a recipient device. This method can be practiced with a system comprising means for receiving a fax request from a user browser, means for uploading content to the user browser, means for receiving a fax job from the user browser, and means for transmitting a facsimile to a recipient device.

The disclosure further relates to a faxing device. In one embodiment, the faxing device comprises a processing device, faxing hardware, and memory comprising a fax control module and an embedded server, the fax control module including logic for generating at least one control screen that can be uploaded to a user browser and at least one application that can also be uploaded to the user browser, the at least one application further being configured to perform a designated task on a computing device on which the user browser runs.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic representation of the general operation of the invention.

FIG. 2 is a schematic view of an example browser-controlled faxing system.

FIG. 3 is a schematic view of a computing device shown in FIG. 2.

FIG. 4 is a schematic view of a faxing device shown in FIG. 2.

FIG. 5 is a flow diagram that illustrates use of the browser of the computing device shown in FIG. 3 in controlling a faxing device.

FIG. 6 is a schematic representation of content that is uploaded into the browser shown in FIG. 3.

FIGS. 7A-7C are views of example control screens that can be viewed with the browser shown in FIG. 3.

FIG. 8 is a flow diagram that illustrates operation of a fax control module of the faxing device shown in FIG. 4.

FIG. 9 is a view of a further example control screen that can be viewed with the browser shown in FIG. 3.

### DETAILED DESCRIPTION

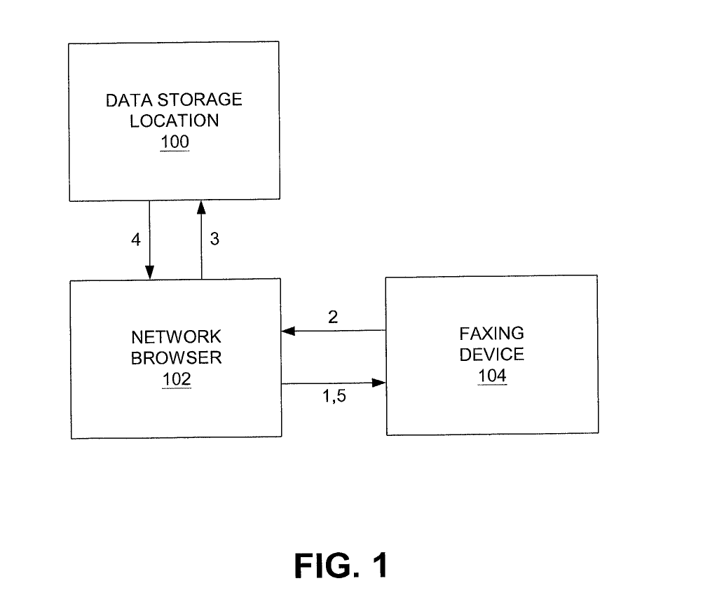

Disclosed herein is a faxing system and method that is controlled with the user's browser. The general operation of the invention is illustrated in FIG. 1. As indicated in this figure, a browser 102 is used to send a use request (indicated by arrow 1) to a faxing device 104. Once this request is made, the faxing device 104 sends content to the browser 102 (arrow 2). As described in greater detail below, this content may comprise one or more pages or screens that can be used to control the faxing device 104. In addition, this content may further comprise small applications (e.g., Java applets) that are embedded in the hypertext markup language (HTML) code of the page displayed by the browser that are configured to, for instance, retrieve media to be faxed (e.g., a word processing document) and manipulate it. After this content has been provided to the browser 102, the browser (or aspects of its content) can retrieve data (arrows 3 and 4) representing the media to be faxed from a data storage location 100. Once retrieved, this data can be translated into a format the faxing device 104 understands and finally sent to the faxing device 104 for faxing (arrow 5).

To facilitate description of the invention, an example browser-controlled faxing system will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which faxing control can be achieved.

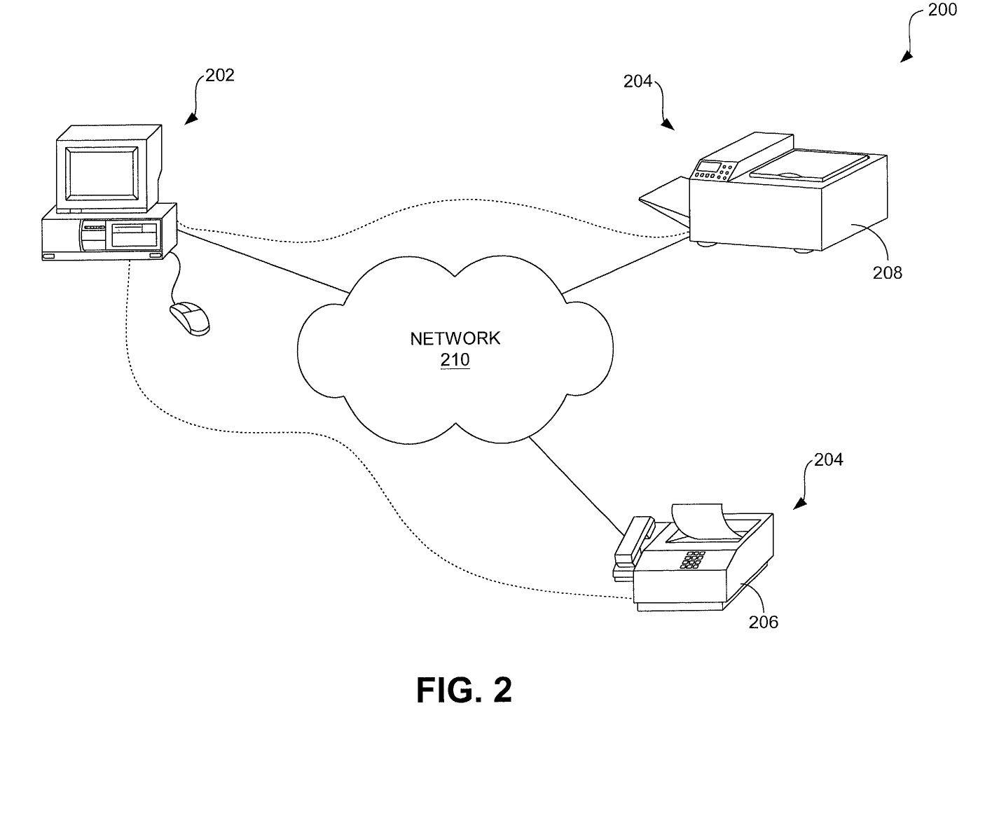

Referring now in more detail to FIG. 2, illustrated is an example browser-controlled faxing system 200. As indicated in this figure, the system 100 generally comprises a computing device 202 and one or more faxing devices 204. As shown in FIG. 2, the computing device 202 can comprise a personal computer (PC). However, it is to be understood that the computing device 202 can comprise substantially any device that can be used to access and use a faxing device. Therefore, the computing device could, alternatively, comprise a laptop computer, personal digital assistant (PDA), mobile telephone, etc. For the purposes of this disclosure, the term “faxing device” is used to denote any device that is capable of sending data by telephonic transmission. Therefore, the faxing device 204 can, for instance, comprise an independent facsimile machine 206 or a multifunction peripheral (MFP) 208, sometimes referred to as an “all-in-one,” that is capable of faxing as well as other different functionalities.

As is further identified in FIG. 2, the computing device 202 and the faxing devices 204 can be connected to a network 210. The network 210 typically comprises one or more sub-networks that are communicatively coupled to each other. By way of example, these networks can include one or more local area networks (LANs) and/or wide area networks (WANs). Indeed, in some embodiments, the network 210 may comprise a set of networks that forms part of the Internet. As is also depicted in FIG. 2, the computing device 202 can, optionally, be directly connected to one or both of the faxing devices 204. Such an arrangement is likely in a home or small office environment in which the user does not have access to a network and instead directly communicates to a faxing device 204. In such a scenario, communication can be facilitated with a direct electrical and/or optical connection or through wireless communication.

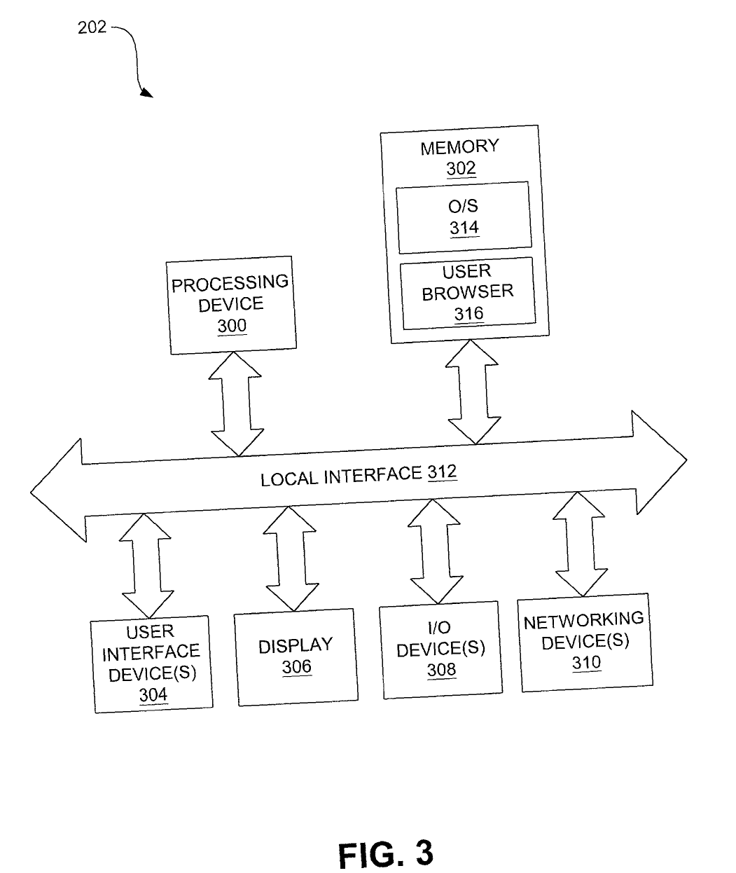

FIG. 3 is a schematic view illustrating an example architecture for the computing device 202 shown in FIG. 2. As indicated in FIG. 3, the computing device 202 can comprise a processing device 300, memory 302, one or more user interface devices 304, a display 306, one or more I/O devices 308, and one or more networking devices 310, each of which are connected to a local interface 312. The processing device 300 can include any custom made or commercially available processor, a central processing unit (CPU) or an auxiliary processor among several processors associated with the computing device 202, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 304 comprise those components with which the user can interact with the computing device 202. Where the computing device 202 comprises a PC or similar device, these components can comprise those typically used in conjunction with a PC such as a keyboard and mouse. Where the computing device 202 comprises a handheld device such as a PDA or mobile telephone, the user interface devices 304 can comprise one or more function buttons or keys. The display 306 can comprise a display typically used in conjunction with a PC such as a computer monitor or plasma screen. Where the computing device 202 comprises a handheld device, the display 306 can comprise a liquid crystal display (LCD) that may or may not be touch-sensitive.

The one or more I/O devices 308 comprise components used to facilitate connection of the computing device 202 to other devices directly, such as the faxing devices 204. Therefore, these devices can, for instance, comprise one or more serial, parallel, small system interface (SCSI), universal serial bus (USB), IEEE 1394 (e.g., Firewire™), or personal area network (PAN) connection devices. The networking devices 310 comprise the various components used to transmit and/or receive data over the network 210. By way of example, the networking devices 310 include a device that can communicate both inputs and outputs, for instance, a modulator/demodulator (e.g., modem), a radio frequency (RF) or other transceiver, a telephonic interface, a bridge, a router, as well as a network card, etc.

The memory 302 normally comprises various software programs including an operating system 314 and a user browser 316. Although various other software programs may be stored in memory 302, they are typically not required to obtain the faxing control that is the subject of the present disclosure and therefore have not been identified. The operating system 314 controls the execution of other software, such as the browser 316, and provides scheduling, input-output control, file and data management, memory management, and communication control and related services. The browser 316 comprises the software that is used to browse data over the network 210 and, as described in greater detail below, thereby access and use the faxing devices 204. The browser 316 typically comprises various different components such as a user application that the user can run on the computing device 202 to interface with the browser software. The browser 316 can, for example, comprise a currently available Internet browser such as Microsoft Internet Explorer™ or Netscape Navigator™.

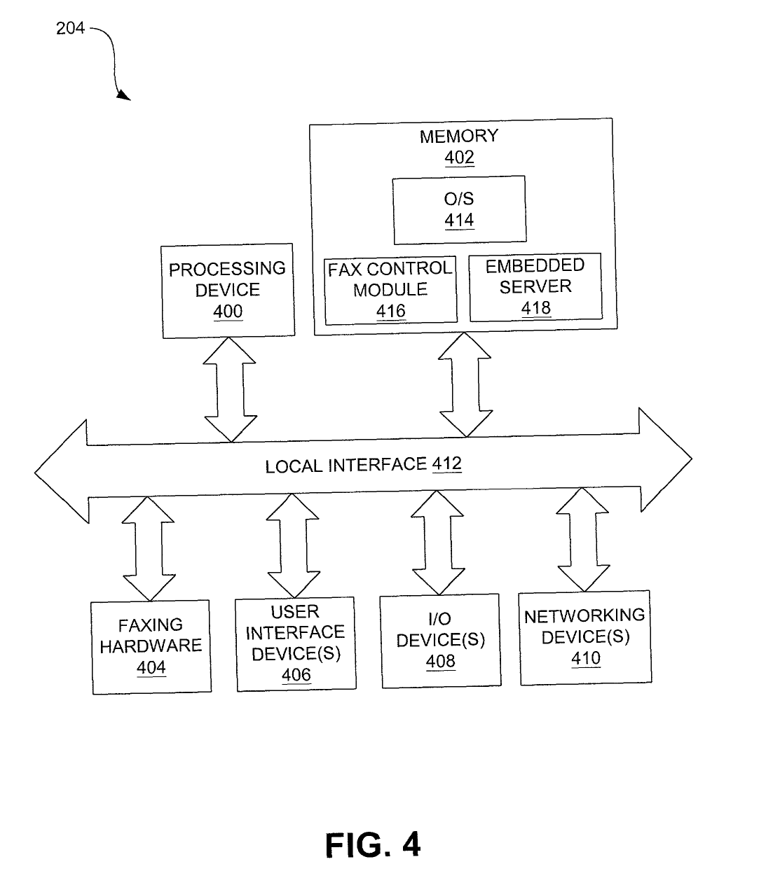

FIG. 4 is a schematic view illustrating an example architecture for the faxing devices 204 shown in FIG. 1. As indicated in FIG. 4, each faxing device 204 can comprise a processing device 400, memory 402, faxing hardware 404, one or more user interface devices 406, one or more I/O devices 408, and one or more networking devices 410. Each of these components is connected to a local interface 412 that, by way of example, comprises one or more internal buses. The processing device 400 is adapted to execute commands stored in memory 402 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the faxing device 204.

The faxing hardware 404 comprises the components with which the faxing device 204 can transmit data along a telephone line. In addition, the faxing hardware 404 can comprise those components used to scan hardcopy documents into electronic form. In such a scenario, the faxing hardware 404 could include a paper drive mechanism, light source (e.g., fluorescent light), light-sensing devices (e.g., charge-coupled devices (CCDs)), and various optics (e.g., lenses, mirrors). The one or more user interface devices 406 typically comprise interface tools with which the device settings can be changed and through which the user can communicate commands directly to the faxing device 204. By way of example, the user interface devices 406 comprise one or more function keys and/or buttons with which the operation of the faxing device 204 can be controlled, and a display, such as a liquid crystal display (LCD), with which information can be visually communicated to the user. Finally, the I/O devices 408 and networking devices 410 can have configurations similar to like-named components identified above with reference to FIG. 3.

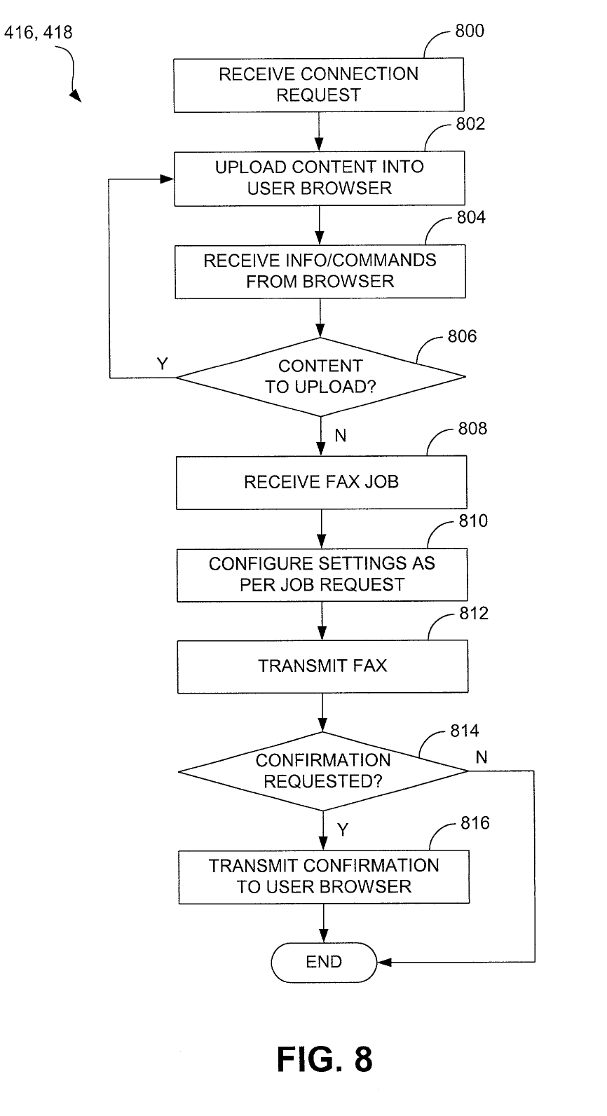

The memory 402 includes various software (e.g., firmware) programs including an operating system 414, fax control module 416, and an embedded server 418. The operating system 414 contains the various commands used to control the general operation of the faxing device 204. The fax control module 416 comprises the various code used to control the operation of the faxing hardware 404 in response to commands received from the user (e.g., over the network 210). The operation of the fax control module 416 is described in detail with respect to FIG. 8 below. The server 418 comprises the software (e.g., firmware) that is used to serve-up data to browsers that request the data. By way of example, the data can comprise one or more pages or control screens and one or more small programs that are configured to perform discrete tasks.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 200 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

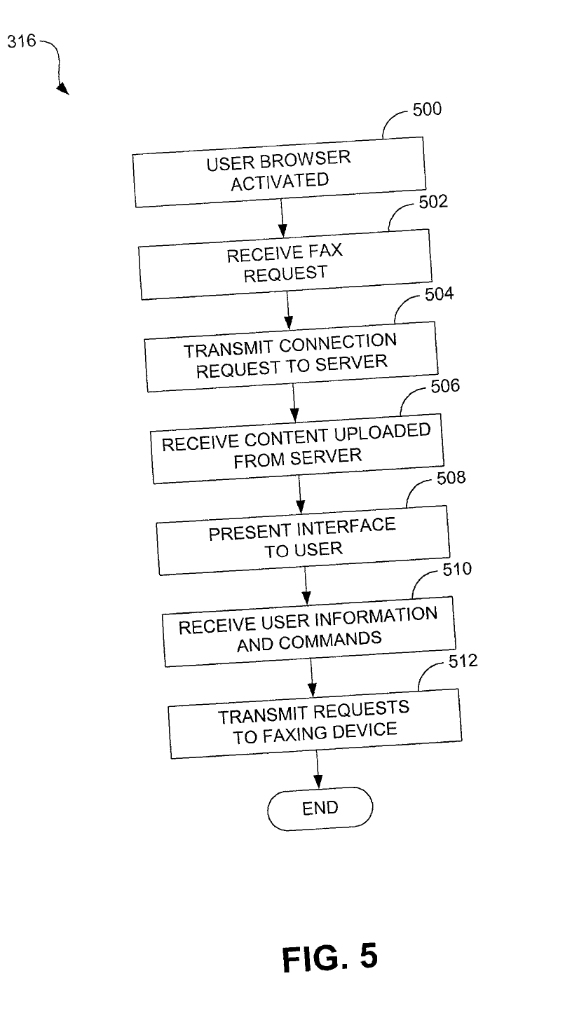

As noted above, the system 200 generally operates so as to facilitate control of a faxing device with the user's browser, for example, browser 316. An example of the operation of the browser 316 as used to control a faxing device 204 is provided in FIG. 5. Beginning with block 500 of this figure, the browser 316 is first activated. This activation can occur in response to a variety of stimuli. Typically, however, activation occurs in response to the user opening the browser 316 from the system desktop. In any case, once activated, a fax request can be received from the user, as indicated in block 502 this request can be transmitted via the network 210 or through a direct connection. In that faxing will ultimately be conducted by the faxing device 204, the fax request is also a request to access the faxing device. The fax request can be entered in a variety of ways. In a simplified case, the user can have entered the network address of the server 418 of the faxing device 204. By way of example, this address can comprise a universal resource locator (URL) that the browser 316 can use to make calls to the faxing device server 418.

In another case, the user can have selected a “faxing device” link stored within a “favorites” listing that forms part of the browser 316. By way of example, this link could have been created manually by the user, automatically added to the favorites list by content uploaded to the browser 316 when the embedded server 418 is first accessed with the browser, etc. In a further case, the user can have selected a “fax” button provided on the tool bar of the browser 316 which again was either manually added by the user or automatically added by content uploaded to the browser.

Once the fax request has been received, and the address of the faxing device 204 therefore has been provided, the browser 316 transmits a connection request to the server 418 of the faxing device 204, as indicated in block 504. This request is then received by the server 418 and the server maps the address of the browser 316 to one or more pages. Through this action, various content is uploaded to the browser 316 and is therefore “received” by the browser as indicated in block 506. As will be appreciated by persons having ordinary skill in the art, the nature of this content depends upon the operations desired.

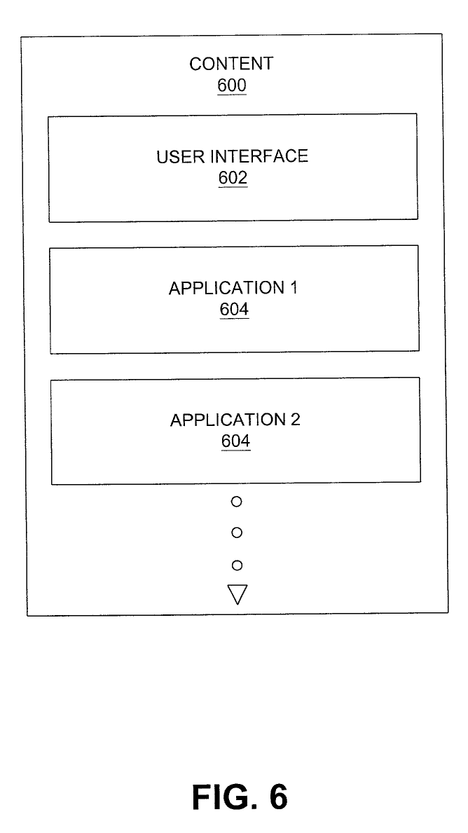

A schematic representation of the uploaded content is provided in FIG. 6. As indicated in this figure, the content 600 can comprise a user interface 602, such as a graphical user interface (GUI), with which the user can make selections to communicate commands to the faxing device 204. This user interface 602 is configured to present to a series of pages or control screens to the user that are viewable in a viewing window of the browser 316. In addition to the interface 602, the content 600 can comprise a plurality of small applications 604, generally referred to as applets (e.g., Java applets), that are configured to perform various tasks. For example, as discussed below, one application 604 can be configured to retrieve, translate, and transmit to the faxing device 204 a document to be faxed.

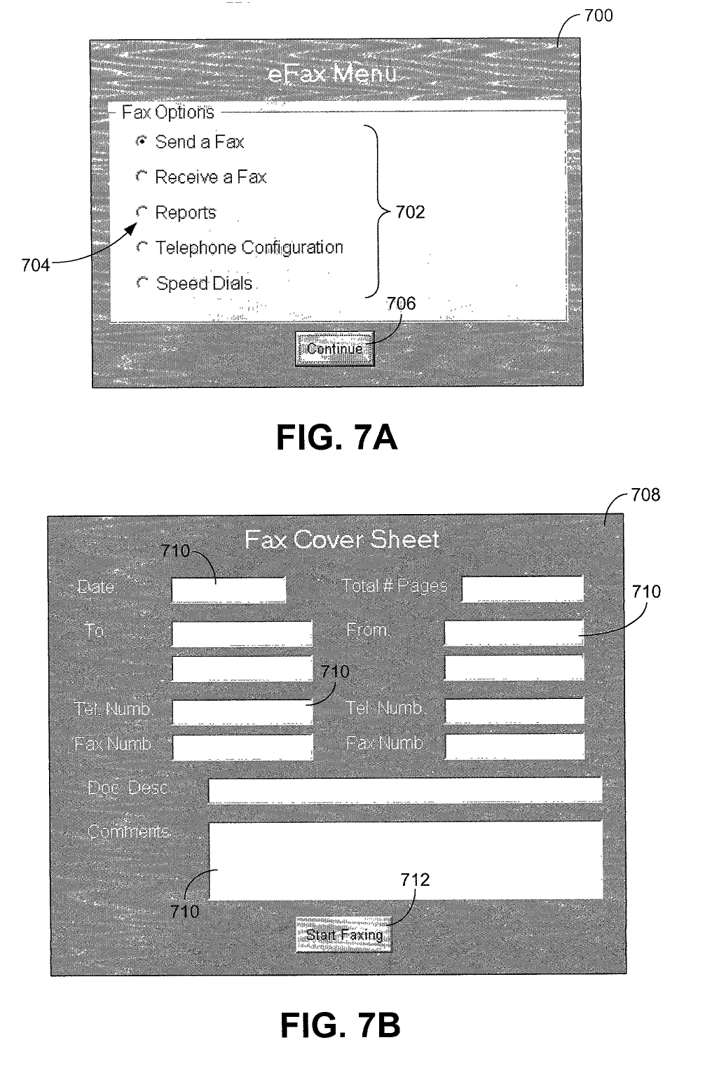

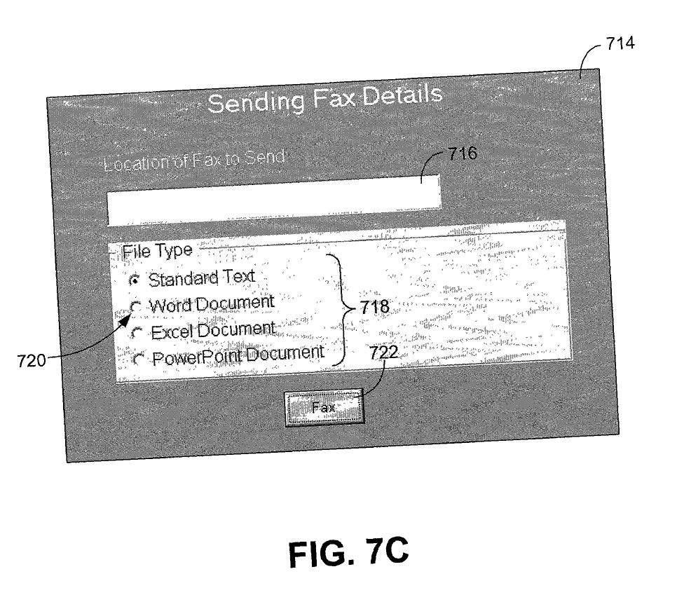

Once the content 600 has been received, the user interface is presented to the user, as indicated in block 508. Where the interface comprises a GUI, one or a series of pages or control screens can be displayed to the user in the viewing window of the browser 316. FIGS. 7A-7C provide several example screens that can be displayed to the user. FIG. 7A illustrates a fax menu screen 700 that can be displayed to the user. By way of example, this screen 700 can be the first screen that is presented to the user. However, it is to be understood that the menu screen 700 need not necessarily be the first. For instance, where the faxing device 204 is capable of performing other functions (e.g., printing), the first screen presented to the user may request the user to designate which of the particular available device functionalities is to be accessed.

As is apparent from FIG. 7A, the fax menu screen 700 can present the user with several selectable options 702. These options can include, for example, “Send a Fax,” “Receive a Fax,” “Reports,” “Telephone Configuration,” and “Speed Dials.” As their names suggest, the “Send a Fax” and “Receive a Fax” options pertain to sending and receiving facsimiles, respectively. The “Reports” option can be selected to require a confirmation report for one or more facsimiles that have been sent. The “Telephone Configuration” option can be selected to have an opportunity to set the telephone configuration settings (e.g., tone or pulse, default area code, etc.). Finally, the “Speed Dials” option can be selected to store or choose certain telephone numbers that the user faxes to often.

As indicated in FIG. 7A, the fax menu screen 700 can further include check “boxes” 704 that the user can mark to convey the user's selection. Once the user is satisfied with his or her selection, the user can select a “Continue” button 706 that is provided on the fax menu screen 700. Where the user has selected the “Send a Fax” option 702, selection of the “Continue” button 706 can, for instance, cause a fax cover sheet screen 708 shown in FIG. 7B to be presented in the view window of the browser 316.

The fax cover sheet screen 708 can be used to enter various information that the user may wish to include on a cover sheet that is to accompany the facsimile that is to be transmitted by the faxing device 204. This information can be entered into data fields 710 of the screen 708. By way of example, fields can be provided for the transmission date, total number of pages, sender information, recipient information, etc. In addition, the fax cover sheet screen 708 can further include a “Start Faxing” button 712. In that facsimiles normally cannot be faxed without a sender's telephone number being provided, the fax cover sheet screen 708 may be configured such that the “Start Faxing” button 712 is inactive until at least the sender's telephone number has been entered. Notably, the user may not need to manually enter this number if the number is contained within the data accessible through selection of the “Telephone Configuration” option 702 of the fax menu screen 700.

Assuming the sender telephone number has been provided in some manner, selection of the “Start Faxing” button 712 can cause a fax details screen 714 of FIG. 7C to be displayed. As indicated in this figure, the fax details screen 714 can include a data field 716 in which the user can enter the name and location of the file that the user wishes to fax. By way of example, this information could be in the format of “c:\folder\subfolder\document” where the document resides on the hard disk of the user's computing device 202. Alternatively, the user can be provided with a drop-down menu (not shown) in which the user can browse through the contents of the user's hard disk (e.g., via a tree directory). Such functionality can be provided where one of the applications 604 uploaded to the browser is configured to make a common dialogue request to the operating system 314 of the computing device 202.

In addition to entering the name and location of the document to be faxed, the user can further identify the file type so that an application 604 responsible for translating the document will know which translation algorithms to use. This can be accomplished, for example, by providing several file type options 718 to the user and permitting the user to select one by marking a check box 720. Options can include, for instance, “Standard Text,” “Word Document,” “Excel Document, ” “PowerPoint Document.” In an alternative embodiment, one of the uploaded applications 604 can be configured to automatically determine the document type (e.g., with reference to the document file extension). Once the various information has been entered, the user can select a “Fax” button 722 to initiate transmission of the fax job to the faxing device 204.

Returning now to FIG. 5, the browser 316 can receive the various information and commands entered by the user, as indicated in block 510, and transmit requests to the faxing device 204, as indicated in block 512. For example, if the user had completed each of the screens presented in FIGS. 7A-7C, the browser 316 transmits a request to fax a document to an intended recipient to the server 418. At this point, a further application 604 can be uploaded to the browser 316 (if not already uploaded) that is configured to retrieve the identified document file, translate it into a format the faxing device 204 understands (e.g., JBIG), and transmit the translated file to the faxing device 204 for fax transmission to a recipient device. As mentioned above, once the faxing device 204 successfully transmits the facsimile, the faxing device can send a confirmation notice to the browser 316 via the network 210 so that the user can know that the requested task was properly completed.

FIG. 8 illustrates an example of the operation of the fax control module 416 and the server 418 of the faxing device 204 in the sending a facsimile scenario. As illustrated in this figure, these two components work in concert in such a scenario. The server 418, and, therefore fax control module 416, first receives the connection request from the browser 316 in the manner described above, as indicated in block 800. At this point, the fax control module 416 identifies the content that is to be provided to the browser 316 so that, as indicated in block 802, the content can be uploaded into the browser. Again, this content can comprise user interfaces and various applications (e.g., Java applets). Next, information and commands can be received from the browser 316, as indicated in block 804. As noted above with reference to FIGS. 7A-7C, the information and commands can be provided by the user by entry with the one or more screens displayed in the user's browser 316.

As the information and commands are received, it is determined whether more content is to be uploaded, as indicated in decision element 806. For example, if the user completes and transmits one of the screens shown in FIGS. 7A or 7B, such additional content can include the next sequential screen to be displayed to the user. In another example, if the sending fax details screen 714 has been completed and transmitted to the embedded server 418, additional content can include an application 604 that is adapted to retrieve the document file of a document to be faxed, translate the document file, and transmit the translated document file to the faxing device 204 for fax transmission.

If further content is to be uploaded, flow returns to block 802 at which the content is uploaded to the browser 316. If, on the other hand, no additional content is to be provided to the browser, i.e., all information necessary for sending a fax transmission has been provided by the user, flow continues to block 808 at which the translated document file, now a fax job, is received. Once the job is received, it can be processed in conventional manner. Accordingly, the settings of the faxing device 204 can be configured to satisfy the requirements for the fax job, as indicated in block 810. At this point, the document file can be transmitted via a telephone line, as indicated in block 812.

With reference to decision element 814, if confirmation was not requested by the user, flow is terminated. If, on the other hand, the user indicated that confirmation was required (e.g., through selection on a menu accessible through the “Reports” option 702 of the fax menu screen 700 in FIG. 7A), flow continues to block 816 at which a confirmation notice is transmitted to the user's browser (assuming the facsimile transmission was successful) and the faxing session is terminated.

As will be appreciated from the above discussion, several advantages are provided with the disclosed system and method. First, in that all the software necessary for providing fax control is stored on the faxing device 204 and uploaded from that device to the user's browser 316, there are no software applications for the user to download. In that the user's browser 316 is used as the user interface, the user further does not have to become accustomed to disparate user interfaces of many different applications, thereby providing interface standardization. Furthermore, due to the centralization of the software, any software updates can be implemented on the faxing device 204 alone but will be available to all users immediately. Moreover, in that the user's browser is used independently of the user's operating environment, the faxing device manufacturer need not rewrite the software every time a third party software manufacturer updates its operating system. Although these advantages have been identified, persons having ordinary skill in the art will appreciate that other advantages exist. Furthermore, such persons will appreciate that, depending upon the particular embodiment that is implemented, one or more of these advantages may not necessarily apply.

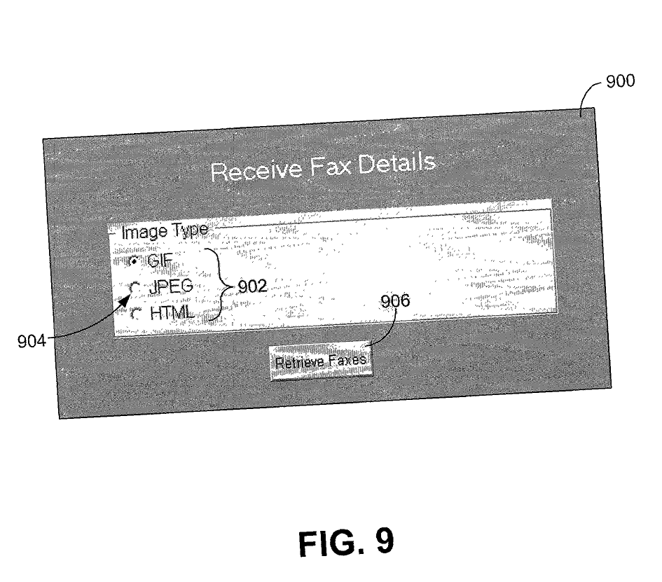

In addition to sending facsimiles via the computing device 202, the user may further wish to view and/or store facsimiles received by the faxing device 204 with his or her computing device. As is known in the art, transmissions received by the faxing device 204 can be stored within device memory 402 and, if the user desires, transmitted to the user's computing device 202 for viewing and/or storing. With the present system 200, however, the user can view the received facsimile transmissions with the browser 316. To permit for this functionality, the facsimile transmission typically must be converted into a format supported by a browser. The user can be given the opportunity to select which format is used, for instance, with a receive fax details screen 900 shown in FIG. 9. As indicated in this figure, the screen 900 can include several format options 902 from which the user can chose, for example by marking an check box 904. As indicated in FIG. 9, the options 902 can include various graphics formats including GIF and JPEG, and can also include HTML. Once the selection has been made, the user can select the “Retrieve Faxes” button 906 at which point a request is made to the embedded server 418 of the faxing device 204 to upload any facsimiles that have been received. Where more than one facsimile has been received, a list of the received transmissions can be presented to the user with the browser 316 for further selection.

Once the desired facsimile transmission has been selected, it can be presented to the user in a variety of ways. For example, each page of the transmission can be represented in thumbnail form and the full page version displayed when each individual thumbnail is selected. Alternatively, each page can be presented one-by-one with each further page being accessed by the user by selecting a “next” button. In a further alternative, each page of the facsimile transmission can be provided on one “page” such that each transmission page is viewed by scrolling downwardly from the first transmission page to the last. In any case, the user can further be provided with the option of storing the facsimile transmission on the hard disk of the computing device 202. Again, these tasks can be performed by one or more applications uploaded to the browser 316, if desired. Where the format of the transmission is one that is supported by a word processing application, the transmission can further be saved as a word processing (e.g., Word™) document, if desired. As will be understood by persons having ordinary skill in the art, the advantages noted above with respect to sending facsimiles apply equally to the facsimile retrieval context.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for faxing a document, comprising the steps of:
receiving a fax request from a user browser;
uploading content to the user browser;
receiving a fax job from the user browser; and
transmitting a facsimile to a recipient device.

2. The method of claim 1, wherein the step of uploading content to the user browser comprises uploading logic configured to generate at least one control screen for display within the browser.

3. The method of claim 1, wherein the step of uploading content to the user browser comprises uploading at least one application that is configured to perform a designated task on a computing device on which the browser runs.

4. The method of claim 3, wherein the at least one application is configured to determine the contents of a hard disk of the computing device.

5. The method of claim 3, wherein the at least one application is configured to retrieve a selected file, translate it, and transmit the translated file back a faxing device.

6. The method of claim 1, further comprising the step of receiving information transmitted from the user browser.

7. The method of claim 1, wherein the step of receiving information comprises receiving a file name and location.

8. The method of claim 7, wherein the step of receiving information further comprises receiving a document type.

9. The method of claim 1, further comprising uploading a confirmation notice to the user browser once a facsimile has been successfully transmitted.

10. A system for faxing a document, comprising:
means for receiving a fax request from a user browser;
means for uploading content to the user browser;
means for receiving a fax job from the user browser; and
means for transmitting a facsimile to a recipient device.

11. The system of claim 10, wherein the means for uploading content to the user browser comprise means for uploading logic configured to generate at least one control screen for display within the browser.

12. The system of claim 10, wherein the means for uploading content to the user browser comprises means for uploading at least one application that is configured to perform a designated task on a computing device on which the browser runs.

13. A system for faxing a document stored on a computer readable medium, comprising:
logic configured to receive a fax request from a user browser;
logic configured to upload content to the user browser;
logic configured to receive a fax job from the user browser; and
logic configured to transmit a facsimile to a recipient device.

14. The system of claim 13, wherein the logic configured to upload content to the user browser comprise logic configured to upload logic configured to generate at least one control screen for display within the browser.

15. The system of claim 13, wherein the logic configured to upload content to the user browser comprises logic configured to upload at least one application that is configured to perform a designated task on a computing device on which the browser runs.

16. A faxing device, comprising:
a processing device;
faxing hardware; and
memory comprising a fax control module and an embedded server, the fax control module including logic for generating at least one control screen that can be uploaded to a user browser and at least one application that can also be uploaded to the user browser, the at least one application further being configured to perform a designated task on a computing device on which the user browser runs.

17. The device of claim 16, wherein the at least one application is configured to determine the contents of a hard disk of the computing device.

18. The device of claim 16, wherein the at least one application is configured to retrieve a selected file, translate it, and transmit the translated file back to the faxing device.

19. The device of claim 16, wherein the at least one application comprises a Java applet.
